(19) United States
(12) Patent Application Publication
(10) Pub. No.: US 2002/0153803 A1
(43) Pub. Date: Oct. 24, 2002

(54) Electrical machine

(76) Inventors: Gerhardt Pflueger, Markgroeningen (DE); Hans-Peter Groeter, Vaihingen (DE)

Correspondence Address: MALCOLM J ROMANO, 116 S CITRUS AVE, LOS ANGELES, CA, 90036, US

(21) Appl. No.: 09/958,409

(22) PCT Filed: Dec. 19, 2000
(86) PCT No.: PCT/DE00/04515

(30) Foreign Application Priority Data
Feb. 10, 2000 (DE) 100 05 781.0

(51) Int. Cl. H02K 1/22

(52) U.S. Cl. 310/263

(57) ABSTRACT

The invention concerns an electrical machine, in particular an alternator, having a stator situated in a housing and carrying a stator winding, and having a claw-pole rotor system that is supported on a shaft and has two pole rings designed as pole pieces that extend outward to form claws that mesh into each other, and having a field coil enclosed by the claw-pole rotor system, in particular situated on the shaft.

It is provided that the claw poles (15, 15′) are permanently connected to each other by way of a ring-shaped claw connecting band (30) situated on the shaft side and produced as a single part out of non-magnetic sheet metal, whereby the claw connecting band is designed with shaped connecting elements (31) that fill the spaces between the claws (19).

The invention concerns an electrical machine, in particular an alternator for motor vehicles.

### RELATED ART

It is known that generators, in particular alternators, can be used in motor vehicles to charge the starter battery and supply power to the electrical components of the vehicle electrical system. The central component of alternators is a claw-pole rotor system situated on a rotor shaft and that rotates at a high rate of speed, and that comprises a field coil that is also situated on the shaft. The claw-pole rotor system is constructed of two pole pieces having opposite polarity, the poles (claws) of which mesh into each other in alternating fashion. The claw poles must thereby be magnetically separated from each other and, at the same time, they must be situated on the rotor shaft in a fashion that ensures torsional stability.

When the alternator is operated, undesired noises are produced, with a distinction being made between two different sources of noise. The noise emission resulting from the vibration of the claw poles induced by electromagnetic forces is called the “magnetic noise”. Moreover, the air flowing through the spaces between the claws and the air turbulences produced in the spaces between the claws leads to an aerodynamic source of noise, the “flow noise”.

It is known that the vibration of the claw poles can be prevented using a damping band inserted in the claw-pole rotor on the field-coil side that is connected to the claw poles by way of weld seams, for example, thereby reducing the generation of magnetic noise. The flow noise is not reduced using this method, however. Furthermore, it is known to close the space between two adjacent claws using an inserted, non-magnetic element and thereby reduce the flow noise. The disadvantage of this solution is a lack of resistance to centrifugation at high speeds. Moreover, this method does not sufficiently damp the vibration of the claw poles.

U.S. Re. 36,038 describes claw-pole wedges for closing spaces between claws consisting of a non-magnetic material, preferably a plastic, or consisting of a nonmagnetic metal such as aluminum or stainless steel. When the claw-pole wedges are produced using a non-magnetic metal, they are produced via diecasting, pressing, or cold forging, then fit into the spaces between the claws and held in place using mechanical means. A one-piece design of the claw-pole wedges according to the invention in the shape of a ring is also disclosed in the same publication. Although this design reduces the flow noise, it is not capable of suppressing the vibration of the claws and, therefore, the magnetic noise emission, because the claw-pole wedges are not truly attached to the pole ring or the pole claws. A further disadvantage of the technique described is the considerable production expense, because the claw-pole wedges must be manufactured with a very narrow tolerance with regard for their fit so they can be attached to the pole rings without using a further attachment device. Additionally, the use of plastic results in a high degree of wear, while the processing costs associated with the use of a non-magnetic metal for diecasting, pressing, or cold forging are very high.

### ADVANTAGES OF THE INVENTION

In contrast, the machine according to the invention having the features named in claim 1 has the advantage that a claw-pole rotor is used with a claw connecting band that eliminates the flow noise as well as the magnetic noise, whereby the claw connecting band can be manufactured in a simple and cost-effective fashion using welding engineering.

A claw connecting band was developed that can be manufactured in a one-piece design out of sheet metal comprised of a non-magnetic metal. The claw connecting band according to the invention is inserted between the field coil and the pole pieces on the shaft side when the claw-pole rotor system is assembled. The claw connecting band is designed in such a fashion that it contains a multitude of connecting elements formed out of sheet metal that fill the space between two adjacent claw poles, whereby the back of the sheet metal extends along the back side of the claw pole, i.e., between the claw pole and the field coil.

In a preferred embodiment, the claw connecting band is manufactured out of an austenitic material.

It is also provided that the permanent connection between the claw connecting band and the claw poles be produced using welding engineering, preferably laser welding engineering. A particularly suitable site for the application of weld seams is located between the flanks of the claw poles and the connecting elements of the claw connecting band, because a relatively large contact surface is formed here.

A further preferred embodiment stipulates the two-sided design of the claw connecting band with a multitude of bevelled tabs that—in the fully-assembled state—are located radially between the claw bases of one pole piece and the claw tips of the second pole piece, whereby the tabs preferably abut against the claw bases. To achieve an even greater resistance to centrifugation, additional welds can be applied in this region, i.e. between the tabs of the claw connecting band and the claw bases of the pole pieces, as an option.

The claw connecting band according to the invention simultaneously fulfills the function of a claw connection and a damping band in that it fills the spaces between the claws using the connecting elements, on the one hand, and, on the other, it creates a permanent connection of the claw poles with each other. As a result, the claw connecting band according to the invention effectively reduces the magnetic noise emission as well as the flow noise.

Furthermore, the stable connection of the claw poles greatly reduces the speed-dependent, radial bending-up of the claw poles which can quickly lead to damage or even destruction of the entire generator. This not only extends the life of the alternator considerably, rather, this effect can also be used constructively in that the working air gap between the stator bore and pole pieces is reduced and higher output can therefore be achieved.

Compared to the named designs according to the related art, the design of the claw connecting band according to the invention composed of non-magnetic sheet metal has the advantage of simple and cost-effective production, because laborious and expensive processing techniques such as diecasting or cold forging are replaced with laser welding, for example, which is more cost-effective. The one-piece design also greatly reduces the assembly expense. Moreover, the design based on sheet metal allows the production of a tolerance compensation, to a certain extent, during application of the weld seams, which results in a reduction in the requirements for precision of the claw connecting band as well as the pole pieces while allowing an excellent fit to be achieved.

It is also expected that, due to the larger rotor surface, more effective heat dissipation and, therefore, improved cooling of the rotor, can be achieved.

### DIAGRAMS

The invention is explained in greater detail below in design examples using the associated diagrams.

FIG. 1 shows a sectional detail view of an alternator having a traditional claw-pole rotor system;

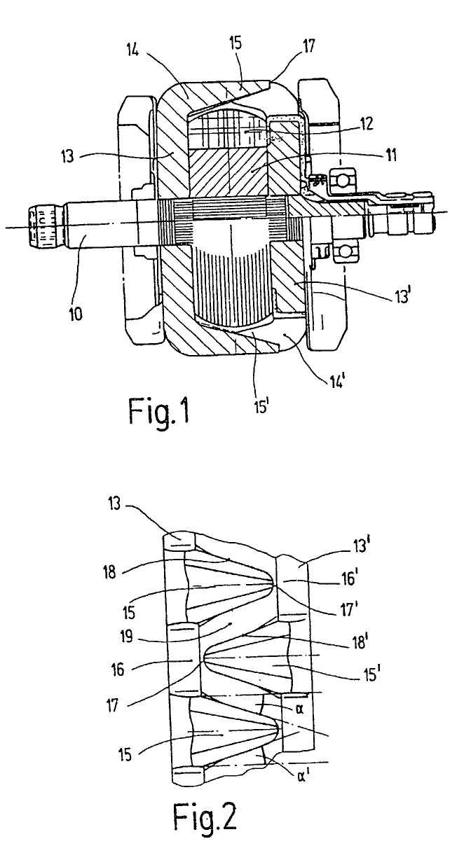

FIG. 2 shows a side part view of the traditional claw-pole rotor system from FIG. 1;

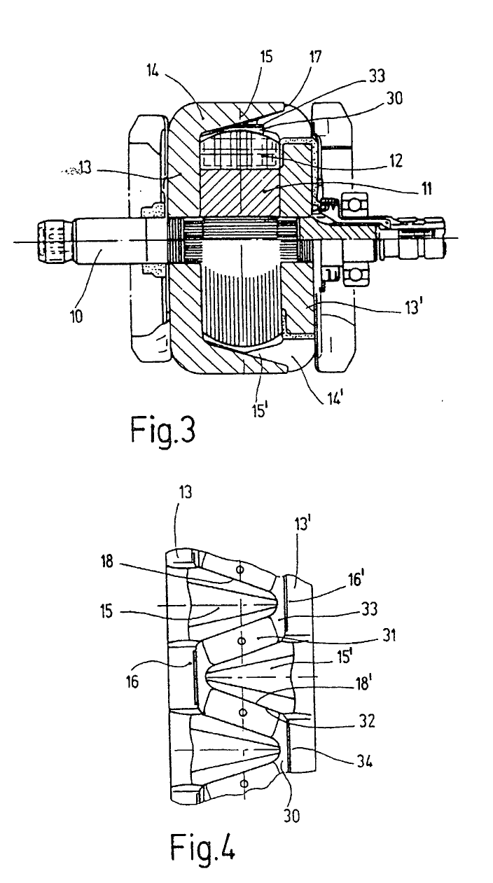

FIG. 3 shows a sectional detail view of an alternator having a claw-pole rotor system with a claw connecting band according to an embodiment of the present invention;

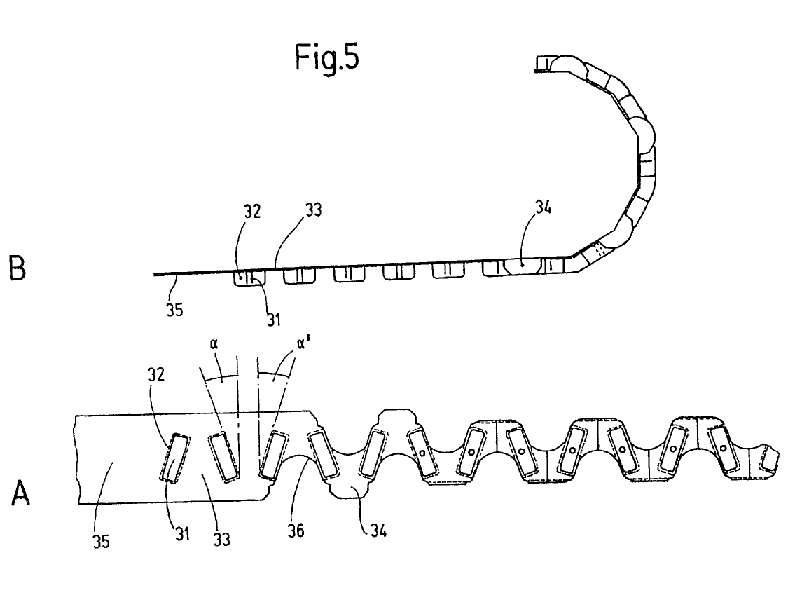

FIG. 4 shows a side part view of the claw-pole rotor system from FIG. 3 with a claw connecting band according to an embodiment of the present invention;

FIG. 5 shows the stages of the process for producing a claw connecting band according to an embodiment of the present invention, whereby A) is a top view, and B) is a side view of a piece of sheet metal to be processed into a claw connecting band in the different stages of production, and

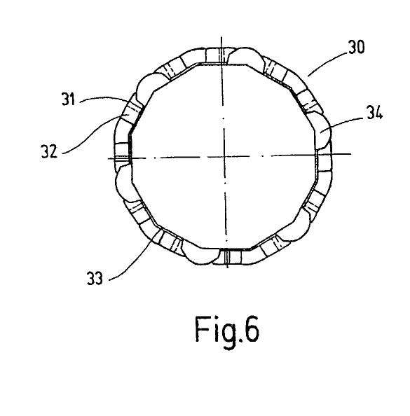

FIG. 6 shows a finished claw connecting band according to an embodiment of the invention.

### DESCRIPTION OF THE EMBODIMENTS

The alternator shown in FIG. 1 comprises a construction, the basic structure of which is known. Only those generator parts that are relevant to the invention, i.e., essentially the components of the rotor, are shown. The generator comprises a rotor shaft 10 having a core 11 mounted on it, on which a field coil 12 is wound coaxially and with torsional stability. The core 11 and the field coil 12 are enclosed by two pole pieces 13 and 13′ having opposite polarity which are also mounted on the rotor shaft 10. Each of the pole pieces 13 and 13′ comprises a pole ring 14 and 14′ designed with claw poles 15 and 15′ designed in the shape of fingers and extending in the axial direction. The pole pieces 13 and 13′ are arranged in such a way that the claw poles 15 and 15′ distributed equidistantly on the pole rings 14 and 14′ mesh into each other in alternating fashion. The laminated stator core that carries the stator winding and encloses the claw-pole rotor system is not shown in this fragmentary view.

FIG. 2 shows a side view of a section of a conventional claw-pole rotor system without claw connecting band. One can see two claw poles 15 of the pole piece 13 facing away from the drive end, and a claw pole 15′ of the drive-end pole piece 13′ that grips in contactless fashion into the gap of the claw pole 15. The claw tip 17′ of the claw pole 15′ of the drive-end pole piece 13′ thereby points toward the claw base 16 of the pole piece 13 facing away from the drive side, and vice versa. A space between the claws 19, each of which is bordered by two parallel claw flanks 18 and 18′, is located between two adjacent claw poles 15 and 15′. The claw flanks 18 and 18′ are tilted axially at an angle of α or α′, respectively, as measured from the rotor shaft 10.

In this traditional construction, as described above, aerodynamic noise-the flow noise-is generated as a result of air flowing through the spaces between the claws 19. A further cause for the undesired noise generation is the vibration of the claw poles 15 and 15′ that occurs as a result of electromagnetic interactions and is therefore also referred to as “magnetic noise”. Both noise emissions increase as the speeds increase; higher speeds are the objective of the alternator according to the general class.

A further problem is posed by the radial bending-up (flaring) of the claw poles that occurs under the influence of high speeds, which can lead to the destruction of the entire generator within a short period of time.

Both sources of noise and the bending-up of the claw poles are eliminated using a claw connecting band according to the present invention. FIG. 3 shows an alternator with a claw-pole rotor system that carries a claw connecting band 30 according to the invention. The same components are identified with the same reference numbers as in FIG. 1. A majority of the structures of the claw connecting band 30 is hidden by the claw pole 15 in this view. Only the sheet metal back 33 of the claw connecting band 30 that is situated between the claw pole 15 and the field coil 12 can be seen.

FIG. 4 shows a fragmentary side view of a claw pole system having an inserted claw connecting band 30 according to the present invention. In this embodiment, the spaces between the claws 19 bordered by the claw flanks 18 and 18′ are filled with inserted connecting elements 31 formed out of an austenitic sheet metal. The long sides 32 of the connecting elements 31 designed in the shape of cuboids in this example abut against the claw flanks 18 and 18′ of the claw poles 15 and 15′. The connecting elements 31 of the claw connecting band 30 are connected to each other by way of the sheet metal back 33, which extends between the back side of the claw poles 15 and 15′ and the field coil 12. In the axial direction, the claw connecting band 30 comprises bevelled tabs 34 on both sides that verge on the claw bases 16 and 16′ of the pole pieces 13 and 13′. The claw connecting band is preferably connected to the pole pieces 13 and 13′ by way of laser welding, whereby the weld seams are preferably applied between the claw flanks 18 and 18′ and the long sides 32 of the connecting elements 31. Additionally, welding can be applied between the tabs 34 and the claw bases 16 and 16′.

The side view presented in FIG. 4 shows clearly that the claw connecting band according to the invention seals every opening in the full-assembled claw-pole rotor system, so that no air can flow through the spaces between the claws when the rotor rotates. Moreover, the claw-pole rotor system, together with the claw connecting band 30, forms a nearly smooth surface in the region of the claw poles 15 and 15′ and the connecting elements 31, so that air turbulences between this region and the stator are reduced considerably. The aerodynamic flow noise is effectively reduced in this fashion. Moreover, the connecting elements 31 and the claw flanks 18 and 18′ comprise a relatively large common contact surface, so that an extremely stable connection of the claw poles 15 and 15′ is achieved via welding in this region. This effectively prevents the claw poles 15 and 15′ from vibrating and, therefore, prevents magnetic noise emission. The bevelled tabs 34 provide additional mechanical rigidity to the rotor when acted upon by centrifugal forces.

FIG. 5 illustrates the production of the claw connecting band 30 according to the invention, whereby A is the top view, and B is a side view of the claw connecting band 30 in various stages of the production process. Starting with a sheet-metal strip 35 comprised of an austenitic material, the connecting elements 31 are first pre-formed using a suitable tool. In this process, the shape of the connecting elements 31—as well as their positioning on the sheet-metal strip 35—is based on the given shape of the claw poles 15 and 15′. In the current example, the connecting elements have a cuboid shape, whereby the long sides 32 of the cuboid are arranged in alternating fashion tilted at an angle of +α and −α as measured from the edge of the sheet metal. The angles correspond to the axial inclination angle of the claw flanks 18 and 18′ as measured from the rotor shaft 10 (compare with FIGS. 2 and 4). In the next step, the sheet-metal strip 35 is cut on both sides, whereby a recess 36 is cut into every open angle formed by two adjacent connecting elements 31. In the present example, the recesses 36 have a nearly half-round shape. In the process of assembling the pole pieces, the recesses 36 serve to accommodate the bevelled back sides of the claw poles 15 and 15′. The tabs 34 are left standing to the side of the closed angle formed by two adjacent, cuboid connecting elements 31 when the recesses 36 are cut out on both sides of the sheet-metal strip 35. In the next step of the production process, the tabs 34 are bevelled at right angles on the side of the sheet metal facing the connecting elements 31. In the same step, the band is roller-burnished over a suitable forming tool, whereby the sheet metal back 33 is situated on the inside, and the connecting elements 31 and the tabs 34 face outward. The ends of the claw connecting band are then connected to each other by way of welding or brazing, and the ring is thereby closed. A finished claw connecting band 30 is shown in a side view in FIG. 6.

When assembling the claw-pole rotor, the claw connecting band 30 is inserted between the two pole pieces and welded in the region of the claw flanks 18 and 18′. A tolerance compensation can thereby be produced to a certain extent at the welding grooves, so that relative minimal demands are to be placed on the precision of the production of the claw connecting band 30. Additionally, however, irregularities in the region of the claw poles 15 and 15′ of the pole pieces 13 and 13′ can be well offset. As an option, additional weld joints can be produced between the claw bases 16 and the tabs 34 of the claw connecting band 30.

Overall, the present invention therefore provides a one-piece claw connecting band that can be produced in simple and cost-effective fashion out of sheet metal. The claw connecting band according to the invention effectively reduces the magnetic noise as well as the flow noise, while also reducing the speed-dependent flaring of the claw poles.

1. Electrical machine, in particular an alternator, having a stator situated in a housing and carrying a stator winding, and having a claw-pole rotor system that is supported on a shaft and has two pole rings designed as pole pieces that extend outward to form claws that mutually mesh into each other, and having a field coil enclosed by the claw-pole rotor system, in particular situated on the shaft, characterized in that the claw poles (15, 15′) are permanently connected to each other by way of a ring-shaped claw connecting band (30) situated on the shaft side and produced as a single part out of non-magnetic sheet metal, whereby the claw connecting band is designed with shaped connecting elements (31) that fill the spaces between the claws (19).

2. Electrical machine according to claim 1, characterized in that the claw connecting band is composed of an austenitic material.

3. Electrical machine according to claim 1 or 2, characterized in that the claw connecting band is connected to the claw poles (15, 15′) using welding engineering, preferably laser welding engineering.

4. Electrical machine according to one of the preceding claims, characterized in that the claw connecting band (30) is welded together with the flanks (18) of the claw poles (15) in the region of the connecting elements (31).

5. Electrical machine according to one of the preceding claims, characterized in that the claw connecting band (30) comprises bevelled tabs (34) that abut against the claw bases (16) of the pole pieces (13).

6. Electrical machine according to one of the preceding claims, characterized in that the claw connecting band (30) is welded together with the claw bases (16) in the region of the tabs (34).
